(19) United States
(12) Patent Application Publication
(10) Pub. No.: US 2016/0164088 A1
(43) Pub. Date: Jun. 9, 2016

(54) POSITIVE ELECTRODE MATERIALS FOR A LITHIUM BATTERY WITH A BASE OF AN OVERLITHIATED LAYERED OXIDE

(71) Applicant: COMMISSARIAT À L'ÉNERGIE ATOMIQUE ET AUX ÉNERGIES ALTERNATIVES, Paris (FR)

(72) Inventors: David Peralta, GRENOBLE (FR); Frederic Fabre, FONTAINE (FR); Pierre Feydi, GRENOBLE (FR); Sebastien Martinet, ST QUENTIN SUR ISERE (FR); Marlene Rey, VEUREY-VOROIZE (FR); Loïc Simonin, GRENOBLE (FR)

(73) Assignee: COMMISSARIAT À L'ENERGIE ATOMIQUE ET AUX ÉNERGIES ALTERNATIVES, Paris (FR)

(21) Appl. No.: 14/906,689

(22) PCT Filed: Jul. 28, 2014
(86) PCT No.: PCT/EP14/66203

§ 371 Date: Jan. 21, 2016

(30) Foreign Application Priority Data
Jul. 29, 2013 (FR) 13 57477

(51) Int. Cl. H01M 4/505; H01M 10/0525; H01M 4/525; C01G 53/00

(52) U.S. Cl. CPC H01M 4/505; C01G 53/50; H01M 10/0525; H01M 4/525; C01P 2006/40; C01P 2006/12; H01M 2220/20; H01M 2220/30

(57) ABSTRACT

The invention relates to a lithium battery positive electrode material comprising a powder of over-lithiated lamellar oxide fitting the following formula (I) :

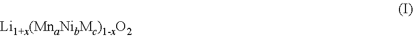

wherein:
x is comprised in a range from 0.1 to 0.26;
a+b+c=1 with the condition that a and b are different from 0;
when c is different from 0, M is a transition element other than cobalt,
said powder having a specific surface area ranging from 1.8 to 6 m²/g and having a tapped density greater than or equal to 1.6 g/cm3.

### TECHNICAL FIELD

The present invention relates to novel lithium-ion battery positive electrode materials based on over-lithiated lamellar oxide as well as to a method for preparing these materials.

Lithium-ion batteries are particularly of interest for fields where autonomy is a primordial criterion, such as this is the case of the fields of computers, video, mobile phones, transports such as electric vehicles, hybrid vehicles, or further in the medical, space or microelectronic fields.

From a functional point of view, lithium-ion batteries are based on the principle of intercalation-deintercalation of lithium within the materials making up the electrodes of the electrochemical cells of the battery.

More specifically, the reaction at the origin of the production of current (i.e. when the battery is in a discharge mode) sets into play the transfer, via a conductive electrolyte of lithium ions, of lithium cations from a negative electrode which will be intercalated into the acceptor lattice of the positive electrode, while electrons from the reaction at the negative electrode will supply the external circuit, to which are connected the positive and negative electrodes.

In lithium-ion batteries, the most critical and the most limiting element proves to be the positive electrode and more specifically the active material of the positive electrode. Indeed, the properties of the active material of the positive electrode are the ones which will determine the energy density, the voltage and the lifetime of the battery.

From among the candidate materials for producing a positive electrode, the family of lamellar oxides and more specifically, the family of over-lithiated lamellar oxides seems to be particularly promising. Generally, the formulations used conventionally comprise nickel, manganese and cobalt. Cobalt has several advantages, notably including the one of increasing the conductivity of the material and of increasing the tapped density. But it also has non-negligible drawbacks, such as its price and an instability, which may be at the origin of a degradation of the material comprising it. One is thus confronted with a blocked situation where the presence of a dopant such as cobalt has risks in terms of safety but where its absence leads to the formation of materials having low density (notably a low tapped density) and electric performances below those obtained with materials comprising such a dopant, notably in terms of cyclability. In order to overcome these drawbacks, it may be necessary to add to the material a protective layer or a dopant layer, which contributes to complicating the manufacturing of the material.

Considering what exists, the authors of the present invention set their goal to develop novel positive electrode materials (which may also be called an active material) not having the drawbacks of the prior art and in particular, having the following advantages:

excellent stability during cycling, whether this is under slow discharge conditions (for example, C/10) and/or under rapid discharge conditions (for example, C/2);

a large bulk specific capacity (for example, which may be of the order of 250 mAh/g);

a large tapped density, for example, greater than or equal to 1.6 g/cm³.

### DISCUSSION OF THE INVENTION

The authors of the present invention have discovered specific positive electrode materials and having a specific surface area range selected in a motivated way, in return for which these materials give the possibility of favorably accessing the advantages mentioned above.

Thus, the invention relates to a lithium-ion battery positive electrode material comprising a powder of over-lithiated lamellar oxide fitting the following formula (I):

Li₁₊ₓ(MnₐNi_{b}M_{c})₁₋ₓO₂ (I)

wherein:
x is comprised in a range from 0.1 to 0.26;
a+b+c=1 with the condition that a and b are different from 0;
when c is different from 0, M is a transition element other than cobalt, and
said powder having a specific surface area ranging from 1.8 to 6 m²/g and preferably having a tapped density greater than or equal to 1.6 g/cm³.

The aforementioned specific surface areas are determined by adsorption of nitrogen at 77 Kelvins with an apparatus of the brand Micrometrics model Tristar II.

More specifically, the determination of the specific surface areas may be described according to the three following steps:

a first step consisting of introducing about one gram of the material to be analyzed, as a powder, into the analyzer followed by leaving it to degas for 4 hours at 180° C. in vacuo;

a second step consist of injecting nitrogen into the analyser, in order to be able to record the adsorption isotherm of nitrogen of the material at 77 Kelvins; and

a third step consisting of reprocessing the thereby obtained isotherm according to the Brunauer-Emmett-Teller model, in order to be able to extract a specific surface area called a BET specific surface area.

The extraction of the BET specific surface area should be accomplished in a well-defined range of nitrogen partial pressures. In the present case here, the regression giving the possibility of extracting the specific surface area is made on five partial pressure values, which are the following: 0.05; 0.10; 0.15; 0.20 and 0.25.

As regards the tapped density, it is specified that this is the density after having tapped a determined mass of powder placed in a burette, this tapped density being more specifically determined according to the following procedure.

Measurement of tapped density is carried out on a specific apparatus of the brand <<Quantachrome Instrument>> model <<Autotap-tap density Analyzer>>. About 5 grams of powder are specifically weighed in a 10 ml graduated burette. The burette is then placed on the apparatus which will tap until the powder volume no longer changes (about 30,000 taps). The tapped density is then obtained by using the following equation:

φt=mV

wherein
φt: specific gravity after tapping (g/cm³)
m: mass of powder (in g)
V: volume after tapping (in cm³).

By determining a given specific surface area range as defined above, it is thus possible to do without the use of cobalt, while having the aforementioned advantages thereof. Furthermore, the resulting material has an immediately stable specific bulk capacity or, at the very least, which stabilizes during the first charging-discharging cycles.

On the basis of this invention, the authors of the present invention were able to end up with the following observations:

with a similar material from the chemical point of view but with a specific surface area below the aforementioned range, the material has a high tapped density, a specific bulk capacity which increases during the first charging-discharging cycles but remaining at a relatively low value;

with a similar material from the chemical point of view but with a specific surface area larger than the aforementioned range, the material has a specific bulk capacity, which substantially drops during the number of charging-discharging cycles.

The surface ranges retained for the materials of the invention thus fall within a motivated selection, since it gives the possibility of accessing materials having:

an immediately stable specific bulk capacity or, at the very least, which will stabilize during the first charging-discharging cycles;

a high tapped density; and

a high specific bulk capacity (for example, of the order of 250 mAh/g).

As mentioned above, the over-lithiated lamellar oxide fits the following formula (I):

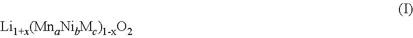

wherein:

x is comprised in a range from 0.1 to 0.26;

a+b+c=1 with the condition that a and b are different from 0;

when c is different from 0, M is a transition element other than cobalt.

When it is present (i.e. when c is different from 0), M may be selected from among Al, Fe, Ti, Cr, V,

Cu, Mg, Zn, Na, K, Ca and Sc.

According to a particular embodiment of the invention, c may be equal to 0, in which case the over-lithiated lamellar oxide fits the following formula (II):

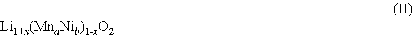

with a, b and x being as defined above.

As for the indexes, a and b, they will fit, in this scenario, into the relationship a+b=1 always with the condition that a and b are different from 0. In addition to this relationship and to that related to the index x, it is generally understood that the values of a, b, c (if required) and x will be selected so that the compound of formula (I) is electrically neutral.

A specific oxide compliant with the definition of the oxides of the aforementioned formula (II) is the oxide of the following formula (III):

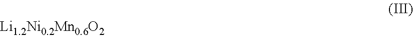

According to a particular embodiment of the invention, the oxide entering the composition of the materials of the invention may have a specific surface area ranging from 1.8 m²/g to 2.8 m²/g and, advantageously, a tapped density greater than 1.6 g/cm³. The authors of the present invention have demonstrated that a material comprising such a compound is particularly suitable for use in a lithium-ion battery subject to slow cycling (i.e. a battery subject to a slow frequency of charging-discharging cycles, for example,

C/10). Indeed, under such conditions, it may be determined that the lamellar oxide has a tapped density greater than 1.6 g/cm³, a specific bulk capacity which may range up to 250 mAh/g and excellent stability during cycling. With this material, it is possible, as confirmed by FIG. 1 enclosed illustrating the time-dependent change of the specific capacity C (in mAh/g) of the material versus the number of cycles N, to obtain an original curve shape, i.e. an increasing curve during the first cycles and which ends up by stabilizing around a capacity value of 250 mAh/g.

For a specific surface area value which would exceed 2.8 m²/g, the material exhibits poor resistance to cycling under slow charging and discharging conditions C/10 as confirmed by FIG. 2, enclosed, illustrating the time-dependent change of the specific capacity C (in mAh/g) of a material with a specific surface area greater than 2.8 m²/g versus the number of cycles N, this figure illustrating a decreasing curve as the number of cycles increases gradually.

According to another particular embodiment of the invention, the compound entering the composition of the materials of the invention may have a specific surface area ranging from 2.3 m²/g to 6 m²/g and, advantageously, a tapped density greater than 1.6 g/cm³. The authors of the present invention have demonstrated that a material comprising such a compound is particularly suitable for use in a lithium-ion battery subject to rapid cycling (i.e., a battery subject to a rapid frequency of charging-discharging cycles, for example, C/2). Indeed, under such conditions, it may be determined that the lamellar oxide has a specific bulk capacity which may range up to 250 mAh/g and has excellent stability during cycling. With this material, it is possible, as confirmed by FIG. 3 enclosed, illustrating the time-dependent change in the specific capacity C (in mAh/g) of the material versus the number of cycles N, to obtain an original curve shape, i.e. an increasing curve during the first cycles and which ends up by stabilizing around a capacity value of 250 mAh/g.

Finally, according to still another embodiment, the compound entering the composition of the materials of the invention may have a specific surface area ranging from 2.3 m²/g to 2.8 m²/g. The authors of the present invention have demonstrated that a material comprising such a compound is particularly suitable for use in a lithium-ion battery which may be subject to both rapid cycling (i.e., a battery subject to a rapid frequency of charging-discharging cycles, for example, C/2) and to slow cycling (i.e., a battery subject to a slow frequency of charging-discharging cycles, for example, C/10). Indeed, in such conditions, it may be determined that the lamellar oxide has both a high tapped density, excellent resistance to cycling and a high specific mass capacity during discharging both in a rapid frequency cycling (around 220 mAh/g) and in a slow cycling frequency (around 250 mAh/g).

With this material, it is possible, as confirmed by FIG. 4 enclosed illustrating the time-dependent change in the specific capacity C (in mAh/g) of the material versus the number of cycles N, to obtain an original curve shape, i.e. an increasing curve during the first cycles and which ends up by stabilizing around a capacity value of 220 mAh/g (curve a) for the rapid cycling frequency) and around a capacity value of 250 mAh/g (curve b) for the slow cycling frequency).

The over-lithiated lamellar oxide should be prepared under operating conditions allowing perfect control of the specific surface area and of the morphology of the obtained powder.

To do this, the authors of the present invention developed a method for preparing a powder of an over-lithiated lamellar oxide of the following formula (I) :

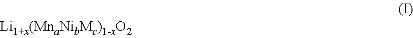

wherein:

x is comprised in a range from 0.1 to 0.26;

a+b+c=1 with the condition that a and b are different from 0;

when c is different from 0, M is a transition element other than cobalt,

said powder having a specific surface area ranging from 1.8 to 6.0 m²/g and preferably, having a tapped density greater than or equal to 1.6 g/cm³, said method comprising the following steps:

a) a step for synthesizing a mixed carbonate comprising the elements Mn, Ni and optionally M;

b) a step for reacting the mixed carbonate obtained in step a) with a lithium carbonate, in return of which is formed the over-lithiated lamellar oxide of the aforementioned formula (I),

the operating conditions for synthesis of the mixed carbonate being set so as to obtain a specific surface area for the lamellar oxide having a value falling under the definition of the range mentioned above.

In the case when the synthesis of the mixed carbonate does not give the possibility of obtaining a lamellar oxide having a value falling under the definition of the range mentioned above, it is possible to modify the calcination temperature of the lithium carbonate/mixed carbonate mixture in a range from 800 to 1,000° C. The modification of the calcination temperature may modify the specific surface area of the final product.

One skilled in the art may determine these operating conditions by elaborating beforehand plans of experiments, from which he will isolate specific operating conditions with view to obtaining a given specific surface area value falling in the aforementioned range.

More specifically, the step for synthesizing a mixed carbonate may consist of co-precipitating with stirring, in a basic medium (for example, a medium comprising ammonia) a solution comprising a manganese sulfate, a nickel sulfate and optionally, a sulfate of M and a carbonate of an alkaline salt (for example, sodium carbonate).

Still more specifically, the step for synthesizing a mixed carbonate may comprise the following operations:

an operation, in a reactor (for example, a reactor of the CSTR type) comprising water, for injecting a solution comprising a nickel sulfate, a manganese sulfate and optionally a sulfate of M (designated below as a solution of sulfates) at a predetermined flow rate, a predetermined stirring rate and at a predetermined pH;

an operation for maintaining the stirring of the formed precipitate for a suitable period for complete formation of the mixed carbonate;

an operation for isolating the precipitate followed by a drying operation in order to form a powder of mixed carbonate.

The particularly influent operating conditions are the aforementioned pH, flow rate and stirring rate (these conditions being mentioned above by the expressions <<predetermined pH>>,<<predetermined flow rate>> and <<predetermined stirring rate>>).

Advantageously, these operating conditions may be set in the following way:

a pH ranging from 7.0 to 8.0, preferably, 7.5;

an injection flow rate of sulfate so that the ratio (sulfate solution flow rate/water volume) in the reactor, is 0.15 mol. h⁻¹.1⁻¹ to 6.8 mol. h^{-1 .}1⁻¹, preferably from 1.30 mol. h⁻¹.1⁻¹ to 6.8 mol. h^{-1 .}1⁻¹;

a predetermined stirring rate selected so as to provide a dissipated power per unit volume ranging from 2.0 W/m³ to 253.2 W/m³, preferably from 2.0 W/m³ to 21 W/m³.

Furthermore, the injection operation and the maintenance operation may be carried out with the same stirring rate and advantageously at a temperature ranging from 50 to 70° C.

The operation for maintaining the stirring may be carried out for a period ranging from 6 to 10 hours.

Finally, the concentration of the solution comprising the sulfates may range from 0.8 to 3 M.

Once the mixed carbonate is produced, that is reacted with lithium carbonate under sufficient conditions for obtaining an over-lithiated lamellar oxide of the aforementioned formula (I). In particular, these conditions conventionally are a temperature associated with a suitable period required for obtaining the over-lithiated lamellar oxide. These conditions may be determined by one skilled in the art by means of preliminary tests, obtaining the intended product (here, the over-lithiated lamellar oxide) may be detected by x-ray diffraction.

As indicated by its name, the material of the invention is a positive electrode material for a lithiumion battery. Therefore it is quite naturally intended to enter the composition of a lithium battery.

Thus, the invention also relates to a lithium battery comprising at least one electrochemical cell comprising an electrolyte positioned between a positive electrode and a negative electrode, said positive electrode comprising a material according to the invention.

By positive electrode, is conventionally meant, in the foregoing and in the following, the electrode which acts as cathode, when the generator produces current (i.e. when it is in a discharge process) and which acts as an anode when the generator is in a charging process.

By negative electrode, is conventionally meant, in the foregoing and in the following, the electrode which acts as an anode, when the generator produces current (i.e. when it is in a discharge process) and which acts as a cathode, when the generator is in a charging process.

The negative electrode may for example be lithium in metal form, or else it may be a material capable of inserting and de-inserting lithium, such as a carbonaceous material like graphite, an oxide material like Li₄Ti₅O₁₂ or a compound capable of forming an alloy with lithium, such as silicon or tin.

The positive electrode, as for it, may comprise, in addition to the material according to the invention, a binder and an electron conducting additive, such as carbon.

The electrolyte, as for it, may generally comprise a lithium salt, for example selected from among LiClO₄, LiAsF₆, LiPF₆, LiBF₄, LiRfSO₃, LiCH₃SO₃, LiN(RfSO₂)₂, Rf being selected as F or a perfluoroalkyl group including from 1 to 8 carbon atoms, lithium trifluoromethanesulfonylimide (known under the acronym of LiTfSI), lithium bis(oxalato)borate (known under the acronym of LiBOB), lithium bis(perfluoroethylsulfonyl)imide (also known under the acronym of LiBETI), lithium fluoroalkylphosphate (known under the acronym of LiFAP).

The lithium salt is preferably dissolved in an aprotic polar solvent.

Further, the electrolyte may be led to impregnate a separator element positioned between both electrodes of the accumulator.

In the case of a lithium accumulator comprising a polymeric electrolyte, the lithium salt is not dissolved in an organic solvent, but in a solid polymer composite, such as polyethylene oxide (known under the acronym of POE), the polyacrylonitrile (known under the acronym of PAN), polymethyl methacrylate (known under the acronym of PMMA), polyvinylidene fluoride (known under the acronym of PVDF), polyvinylidene chloride (known under the acronym of PVC) or one of their derivatives.

Other features will better appear upon reading the additional description which follows, which relates to examples of manufacturing materials according to the invention.

Of course, the examples which follow are only given as an illustration of the object of the invention and by no means are a limitation of this object.

### SHORT DESCRIPTION OF THE FIGURES

FIG. 1 is a graph illustrating the time-dependent change in the specific capacity C (in mAh/g) of a material according to the invention versus the number of cycles N under slow discharge conditions.

FIG. 2 is a graph illustrating the time-dependent change in the specific capacity C (in mAh/g) of a material with a specific surface area greater than 2.8 m²/g (a material non-compliant with the invention), versus the number of cycles N under slow discharge conditions.

FIG. 3 is a graph illustrating the time-dependent change of the specific capacity C (in mAh/g) of a material according to the invention versus the number of cycles N under rapid discharge conditions.

FIG. 4 is a graph illustrating the time-dependent change in the specific capacity C (in mAh/g) of a material according to the invention versus the number of cycles N, said material being subject to slow discharge conditions (curve b) or to rapid discharge conditions (curve a).

FIG. 5 is a graph illustrating the time-dependent change in the specific capacity C (expressed in mAh/g) of the material of Example 1 versus the number of cycles N under rapid discharge conditions (curve b) or under slow discharge conditions (curve a).

FIG. 6 is a graph illustrating the time-dependent change in the specific capacity C (expressed in mAh/g) of the material of Example 2 versus the number of cycles N under rapid discharge conditions (curve b) or under slow discharge conditions (curve a).

FIG. 7 is a graph illustrating the time-dependent change in the specific capacity C (expressed in mAh/g) of the material of Example 2 versus the number of cycles N under rapid discharge conditions (curve b) or under slow discharge conditions (curve a).

FIG. 8 is a graph illustrating the time-dependent change in the specific capacity C (expressed in mAh/g) du material of Example 2 versus the number of cycles N under rapid discharge conditions (curve b) or under slow discharge conditions (curve a).

FIG. 9 is a graph illustrating the time-dependent change of the specific capacity C (expressed in mAh/g) of the material of Example 3 versus the number of cycles N under rapid discharge conditions (curve b) or under slow discharge conditions (curve a).

FIG. 10 is a graph illustrating the time-dependent change of the specific capacity C (expressed in mAh/g) of the material of Example 3 versus the number of cycles N under rapid discharge conditions (curve b) or under slow discharge conditions (curve a).

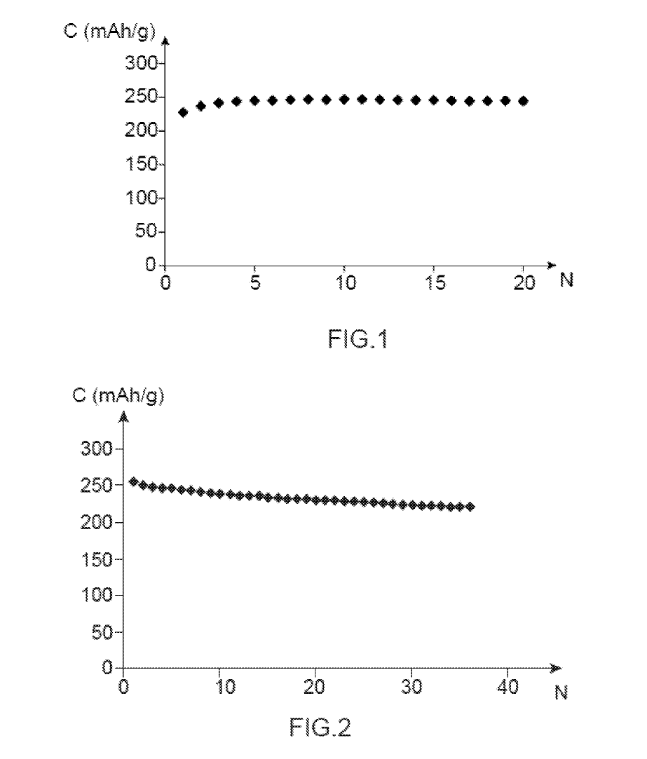

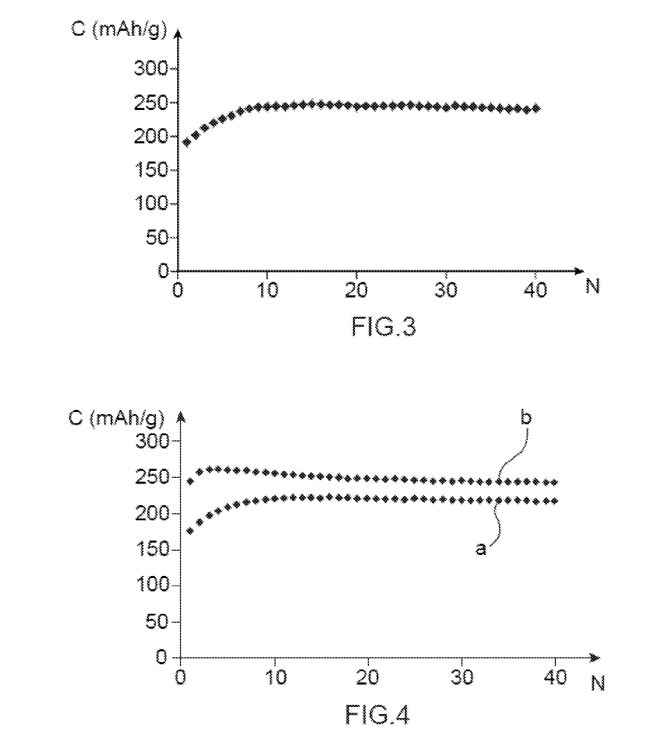

### DETAILED DISCUSSION OF PARTICULAR EMBODIMENTS

### EXAMPLE 1

This example illustrates the synthesis of a lithiated lamellar oxide of formula Li₁.₂Ni₀.₂Mn₀.₆O₂ exhibiting a specific surface area of 1.8 m²/g, said synthesis comprising, in a first phase, the preparation of a nickel and manganese mixed carbonate and then the reaction of this mixed carbonate with a lithium carbonate.

In a reactor of the CSTR type with a capacity of 800 ml, 500 ml of water are introduced and it is heated to 60° C. During the whole preparation of the mixed carbonate, stirring of the mixture is maintained so as to obtain a dissipated power of 54.7 W/m³. A solution of nickel sulfate and manganese sulfate (according to a molar ratio of ⅓ for a concentration of 2M) is continuously injected into the reactor so that the ratio of the injection flow rate of the solution of sulfates/water volume of the reactor is of 0.15 mol. h⁻¹.⁻¹. The pH of the reactor is regulated to 7.5 by adding a 2M sodium carbonate solution and a 0.4 M ammonia solution. The injection is maintained for 120 minutes and then the injection pumps are cut off. During the injection, a precipitate is formed. At the end of the injection, this precipitate is left in the solvent for 6 hours at the same temperature and with the same stirring. At the end of this period of 6 hours, the precipitate is separated from the liquid phase by centrifugation and/or filtration and is then abundantly washed with hot water at 70° C. The obtained mixed carbonate is then dried in an oven in air at 120° C. The thereby formed mixed carbonate is then intimately mixed with a lithium carbonate. The resulting mixture is then calcined at a temperature of 900° C. for 24 hours. The obtained oxide is a lamellar oxide of formula Li₁.₂Ni₀.₂Mn₀.₆O₂ appearing as a powder.

The obtained powder is analyzed by x-ray diffraction (XRD) and is subject to measurements so as to estimate the tapped density, the specific surface area and its electrochemical behavior for C/10 conditions (which correspond to slow discharge conditions) and C/2 (which correspond to rapid discharge conditions).

The aforementioned specific surface areas are determined by adsorption of nitrogen at 77 Kelvins with apparatus of the brand Micrometrics model Tristar II.

More specifically, the determination of the specific surface areas may be described according to the three following steps:

a first step consisting of introducing about one gram of the material to be analyzed, as a powder, in the analyzer followed by degassing for 4 hours at 180° C. in vacuo;

a second step consisting of injecting nitrogen into the analyzer, in order to be able to record the isotherm of nitrogen adsorption of the material at 77 Kelvins; and

a third step consisting of reprocessing the thereby obtained isotherm according to the Brunauer-Emmett-Teller model, in order to be able to extract a specific surface area called the BET specific surface area.

The extraction of the BET specific surface area should be carried out in a well-defined range of nitrogen partial pressures. In the present case here, the regression allowing extraction of the specific surface area is made on five partial pressure values, which are the following: 0.05; 0.10; 0.15; 0.20 and 0.25.

The specific surface area of the oxide is 1.8 m²/g, while its tapped density is 1.6 g/cm³, which gives the possibility of obtaining very good performances in terms of cyclability under slow discharge conditions (C/10) as confirmed by curve a) (for the slow discharge conditions) of FIG. 5 illustrating the time-dependent change in the specific capacity of the oxide (expressed in mAh/g) versus the number of cycles.

In term of capacities, the value of the specific surface area enters the range of the values defined for slow cycling, therefore the capacity obtained under C/10 conditions is high (235 mAh/g). As regards the C/2 conditions, the specific surface area value is less than the range of values defined for rapid cycling, therefore the obtained capacity for C/2 conditions is low (150 mAh/g) as confirmed by curve b) of FIG. 5.

### EXAMPLE 2

This example illustrates the synthesis of a lithiated lamellar oxide of formula Li₁.₂Ni₀.₂Mn₀.₆O₂ comprising, in a first phase, the preparation of a nickel and manganese mixed carbonate and then the reaction of this mixed carbonate with a lithium carbonate. The example will show that it is possible to adjust the specific surface area of a lamellar oxide by modifying the calcination temperature of the lithium carbonate and mixed precursor mixture.

In a reactor of the CSTR type with a capacity of 500 ml, 500 ml of water are introduced and it is heated to 50° C. During the preparation of the mixed carbonate, the stirring of the mixture is maintained so as to have a dissipated power of 2.03 W/m³. A solution of nickel sulfate and manganese sulfate (according to a molar ratio of ⅓ for a concentration of 2M) is continuously injected into the reactor with a flow rate so that the injection flow rate of the solution/water volume of the reactor ratio is 3.3 mol. h⁻¹ .1⁻¹. The pH of the reactor is regulated to 7.5 by adding a 2M sodium carbonate solution and a 0.4 M ammonia solution. The injection is maintained for 5 minutes and then the injection pumps are cut off. During the injection, a precipitate is formed. At the end of the injection, this precipitate is left in the solvent for 8 hours at the same temperature and with the same stirring. At the end of this period of 8 hours, the precipitate is separated from a liquid phase by centrifugation and/or filtration and then is abundantly washed with hot water at 70° C. The thereby formed mixed carbonate is then intimately mixed with a lithium carbonate. The resulting mixture is then calcined at various temperatures (850° C., 875° C. and 900° C. for 24 hours). For all the three calcination temperatures, the obtained oxide is a lamellar oxide of formula Li₁.₂Ni₀.₂Mn₀.₆O₂ appearing as a powder. The obtained oxides have specific surface areas of 1.9 m²/g, 2.7 m²/g and 4.9 m²/g respectively for calcination temperatures of 900° C., 875° C. and 850° C.

The obtained powders are analyzed by x-ray diffraction (XRD) and are subject to measurements so as to estimate the tapped density, the specific surface area and its electrochemical behavior for C/10 conditions (which correspond to slow discharge conditions) and C/2 (which correspond to rapid discharge conditions).

The specific surface area is determined according to the procedure appearing in Example 1 above.

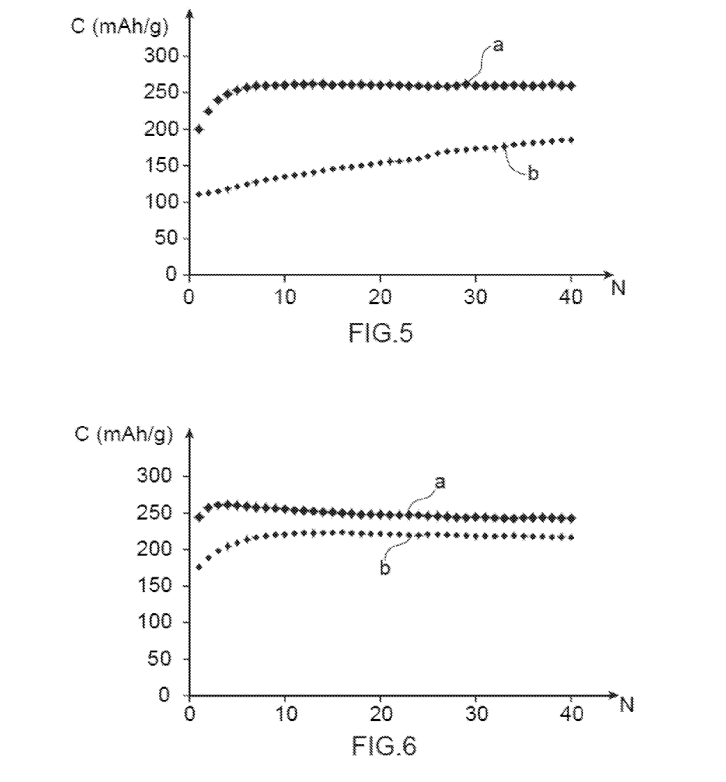

The specific surface area of the oxide synthesized at 875° C. is 2.7 m²/g while its tapped density is 1.7 g/cm³, which gives the possibility of obtaining very good performances under rapid discharge conditions (C/2) and under slow discharge conditions (C/10) both in terms of cyclability and in specific capacity as confirmed by curves a) (slow discharge conditions) and b) (rapid discharge conditions) of FIG. 6 illustrating the time-dependent change in the specific capacity of the oxide (expressed in mAh/g) versus the number of cycles.

The synthesized oxides with temperatures of 900° C. and 850° C. have specific surface areas of 1.9 m²/g and 4.9 m²/g and tapped densities of 1.7 g/cm³, respectively. As these values of specific surface areas are comprised in two different ranges of specific surface area defined in this report, the conditions of use of these materials have to be different.

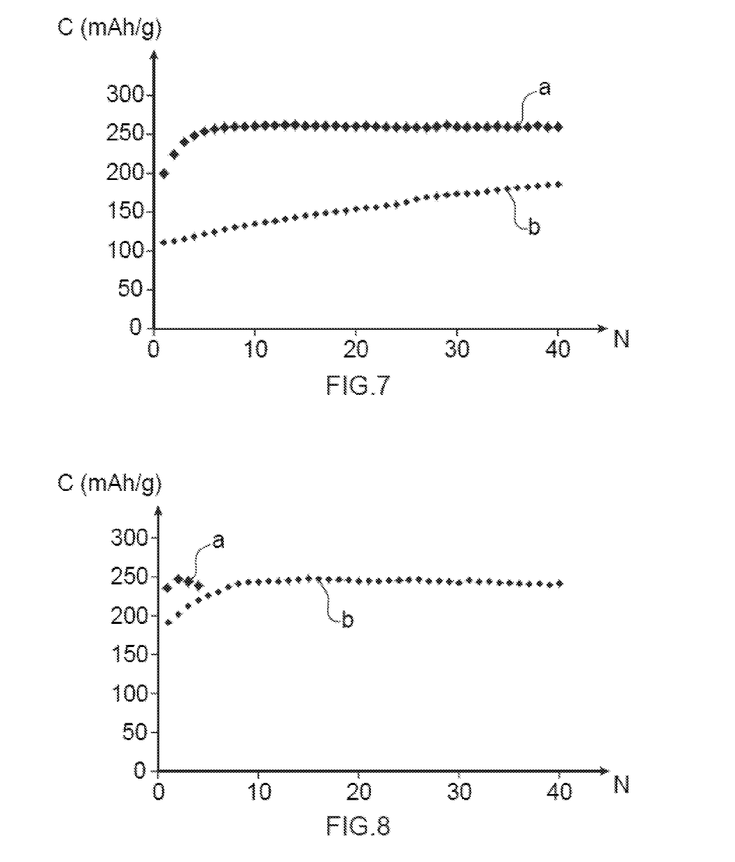

With the material calcined at 900° C., very good performances under slow discharge conditions (C/10) are obtained both in terms of cyclability and in specific capacity as confirmed by curve a) of FIG. 7 illustrating the time-dependent change in the specific capacity of the oxide (expressed in mAh/g) versus the number of cycles. On the other hand, the performances of the material at C/2 are low, as confirmed by the curve b) of FIG. 7.

The oxide synthesized at a temperature of 850° C. have a specific surface area of 4.9 m²/g which enters the range of specific surface area which we defined in this report for rapid discharge conditions of

C/2. Therefore, the synthesized lamellar oxide has poor cyclability under slow C/10 conditions (curve a) of FIG. 8) but has very good performances and very good cyclability for rapid C/2 conditions (curve b) of FIG. 8).

### EXAMPLE 3

This example illustrates the synthesis of a lithiated lamellar oxide of formula Li₁.₂Ni₀.₂Mnₒ.₆O₂ comprising, in a first phase, the preparation of a nickel and manganese mixed carbonate and then the reaction of this mixed carbonate with a lithium carbonate. The example will demonstrate that it is possible to adjust the specific surface area of a lamellar oxide by modifying the calcination temperature of the mixture of lithium carbonate and of mixed precursor.

In a reactor of the CSTR type with a capacity of 65 L, 25 L of water are introduced and it is heated to 50° C. During the whole preparation of the mixed carbonate, the stirring of the mixture is maintained so as to have a dissipated power of 20.8 W/m³. A solution of nickel sulfate and of manganese sulfate (according to a molar ratio of ⅓ for a concentration of 0.8 M) is continuously injected into the reactor with a set flow rate so as to obtain an injection flow rate of the solution/water volume of the reactor ratio of 4.8 mol. h⁻¹.1⁻¹. The pH of the reactor is regulated to 7.5 by adding a 2M sodium carbonate solution and a 0.4M ammonia solution. The injection is maintained for 5 minutes and then the injection pumps are cut off. During the injection, a precipitate is formed. At the end of the injection, this precipitate is left in the solvent for 8 hours at the same temperature and with the same stirring. At the end of this period of 8 hours, the precipitate is separated from the liquid phase and is dried by filtration on a drier filter. The material is abundantly washed with water and is dried on a drier filter after washing. The thereby formed mixed carbonate is then intimately mixed with a lithium carbonate. The resulting mixture is then calcined at different temperatures (850° C. and 900° C. for 24 hours). For both of the calcination temperatures, the obtained oxide is a lamellar oxide of formula Li₁.₂Ni₀.₂Mn₀.₆O₂ appearing as a powder. The obtained oxides have specific surface areas of 1.9 m²/g and 2.8 m²/g for calcination temperatures of 900° C. and 850° C., respectively.

The obtained powders are analyzed by x-ray diffraction (XRD) and are subject to measurements so as to estimate the tapped density, the specific surface area and its electrochemical behavior for C/10 conditions (which correspond to slow discharge conditions) and C/2 conditions (which correspond to rapid discharge conditions).

The specific surface area is determined according to the procedure appearing in Example 1 above.

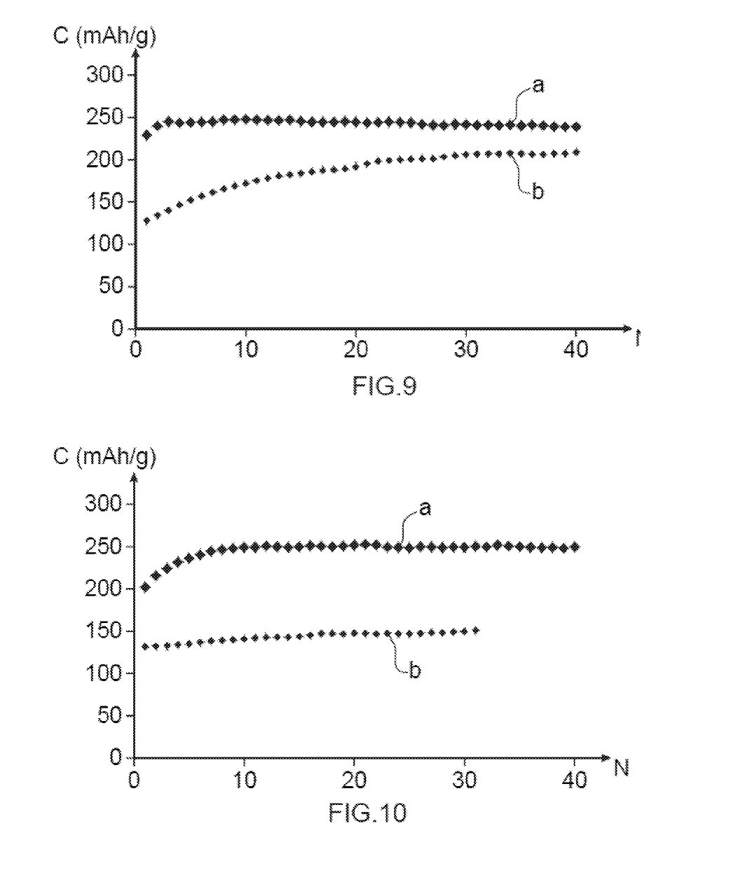

The specific surface area of the synthesized oxide at 850° C. is 2.8 m²/g while its tapped density is 1.7 g/cm³, which gives the possibility of obtaining very good performances under rapid discharge conditions (C/2) and under slow discharge conditions (C/10) both in terms of cyclability and in specific capacity as confirmed by the curves a) (slow discharge conditions) and b) (rapid discharge conditions) of FIG. 9 illustrating the time-dependent change in the specific capacity of the oxide (expressed in mAh/g) versus the number of cycles.

The oxide synthesized with a temperature of 900° C. has a specific surface area of 1.9 m²/g and a tapped density of 1.7 g/cm³. As the specific surface area value is comprised in the specific surface area range defined in this report, very good performances are obtained under slow discharge conditions (C/10) both in terms of cyclability and in specific capacity as confirmed by the curve a) of FIG. 10 illustrating the time-dependent change in the specific capacity of the oxide (expressed in mAh/g) versus the number of cycles. On the other hand, the performances of the material at C/2 are low, as confirmed by the curve b) of FIG. 10.

1. A lithium-ion battery positive electrode material comprising a powder of over-lithiated lamellar oxide fitting the following formula (I): 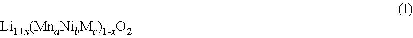
wherein:
x is comprised in a range from 0.1 to 0.26;
a+b+c=1 with the condition that a and b are different from 0;
when c is different from 0, M is a transition element other than cobalt,
said powder having a specific surface area ranging from 1.8 to 6 m²/g and having a tapped density greater than or equal to 1.6 g/cm³.

2. The positive electrode material according to claim 1, wherein, when c is different from 0, M is selected from among Al, Fe, Ti, Cr, V, Cu, Mg, Zn, Na, K, Ca and Sc.

3. The positive electrode material according to claim 1, wherein over-lithiated lamellar oxide fits the following formula (II): 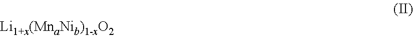
wherein:
x is as defined in claim 1; and
a+b=1 with the condition that a and b are different from 0.

4. The positive electrode material according to claim 1, wherein the over-lithiated lamellar oxide fits the following formula (III):

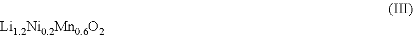

5. The positive electrode material according to claim 1, wherein the oxide powder has a specific surface area ranging from 2.3 m²/g to 6 m²/g.

6. The positive electrode material according to claim 1, wherein the oxide powder has a specific surface area ranging from 2.3 m²/g to 2.8 m²/g.

7. A method for preparing a powder of an over-lithiated lamellar oxide of the following formula (I): 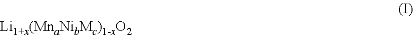
wherein:
x is comprised in a range from 0.1 to 0.26;
a+b+c=1 with the condition that a and b are different from 0;
when c is different from 0, M is a transition element other than cobalt,
said powder having a specific surface area ranging from 1.8 to 6 m²/g and having a tapped density greater than or equal to 1.6 g/cm³, said method comprising the following steps:
a) a step for synthesizing a mixed carbonate comprising the elements Mn, Ni and optionally M;
b) a step for reaction of the mixed carbonate obtained in step a) with a lithium carbonate, in return for which the over-lithiated lamellar oxide of the aforementioned formula (I) is formed,
the operating conditions for synthesizing the mixed carbonate being set so as to obtain a specific surface area for the lamellar oxide having a value falling under the definition of the range mentioned above.

8. The method for preparing a powder of an over-lithiated lamellar oxide according to claim 7, wherein the step for synthesizing a mixed carbonate consists of co-precipitating with stirring, in a basic medium, a solution comprising a manganese sulfate, a nickel sulfate and optionally, a sulfate of M and an alkaline salt carbonate.

9. The method for preparing a powder of an over-lithiated lamellar oxide according to claim 7, wherein the step for synthesizing a mixed carbonate comprises the following operations:
an operation in a reactor comprising water, for injecting a solution comprising a nickel sulfate, a manganese sulfate and optionally a sulfate of M (a so called solution of sulfates) according to a predetermined flow rate, a predetermined stirring rate and at a predetermined pH;
an operation for maintaining the stirring of the precipitate formed for a suitable period for complete formation of the mixed carbonate;
an operation for isolating the precipitate followed by a drying operation for forming a powder of the mixed carbonate.

10. The method for preparing a powder of an over-lithiated lamellar oxide according to claim 9, wherein the predetermined pH ranges from 7.0 to 8.0.

11. The method for preparing a powder of an over-lithiated lamellar oxide according to claim 9, wherein a ratio (flow rate of a solution of sulfates/volume of water) in the reactor is 0.15 mol.h ⁻¹.1⁻¹ to 6.8 mol.h⁻¹.1⁻¹.

12. The method for preparing a powder of an over-lithiated lamellar oxide according to claim 9, wherein the predetermined stirring rate is set so as to obtain a dissipated power per unit volume ranging from 2.0 W/m³ to 253.2 W/m³.

13. A lithium battery comprising at least one electrochemical cell comprising an electrolyte positioned between a positive electrode and a negative electrode, said positive electrode comprising a positive electrode material as defined according to claim 1.
